(19) United States
(12) Patent Application Publication
(10) Pub. No.: US 2004/0179011 A1
(43) Pub. Date: Sep. 16, 2004

(54) Data display method and system

(76) Inventor: James F. Marshall, Germantown, WI (US)

Correspondence Address: JOSEPH S. HEINO, ESQ., DAVIS & KUELTHAU, S.C., 111 E. KILBOURN, SUITE 1400, MILWAUKEE, WI, 53202-6613, US

(21) Appl. No.: 10/388,778

(22) Filed: Mar. 14, 2003

(51) Int. Cl. G06T 11/20

(52) U.S. Cl. 345/440

(57) ABSTRACT

A method and system provides a unique data display tool for use in the investment area and utilizes color coded entries in various data displays to aid in the client's assimilation of investment data and information. More specifically, the method and system uses a plurality of colors that are superimposed over data contained in various data displays. Any one data display may contain a number of different such color overlays. As between different data displays, the same colors would be used for the same data presented in each.

### FIELD OF THE INVENTION

This invention relates generally to methods and systems for acquiring, storing, processing, retrieving and displaying data. More specifically, it relates to a method and system for displaying data in a color coded fashion whereby data is quickly and readily assimilated by a viewer. It also relates to such a method and system whereby data can be color coded so as to be quickly and readily assimilated between various data display tools and media that may be utilized.

### BACKGROUND OF THE INVENTION

The need to pass along information from one person to another in a visual fashion is perhaps the most fundamental communication skill that links all of humanity. Even before verbalization was elevated to an acceptable mode of communication, visual cues formed the essence of mankind's passing of information through geographic and temporal modes. The earliest cave paintings depicted information concerning the identity of great prehistoric heroes and creatures of prey and, ever since, mankind has sought to educate itself by using symbols, letters and numbers to pass along similar information. The need to do so certainly has not diminished. Indeed, in today's hurried society, information is passed along at such a rate and in such volumes that is more than can be reasonably or completely processed by the human eye and mind. Due to this deluge of information, the present inventor believes that it is clearly necessary to reverse the complexity of information that he passes on to his customers and clients and to simplify the visual communication process in the area of business in which he himself is an experienced professional. This inventor has observed the need to facilitate the communication and assimilation process by preparing and making presentations to potential and existing clients and customers as easily understandable as possible. This inventor has also realized a need to present information in such a way that creates a continuum of order and logic between various media and modes of presentation. In the abstract, for example, one visual display in the area of investments and asset management may be designed specifically for allowing the client or customer to view actual current information relevant to that client and to his or her investment portfolio. Another visual display may be designed for allowing the client or customer to view historical trends relevant to that client's investments. Rather than creating each visual display in such a way that the client or customer is required to reorient himself or herself to the data that he or she is attempting to assimilate between each display, a far better approach is to create visual commonality between the data illustrated in the one visual display with the data illustrated in the other display such that the client's assimilation of the information is greatly enhanced. In this way, the client's enhanced understanding of that information is also realized.

What is needed is a method and system that displays data in the area of investments and asset management in such a way that the client or customer can view various media displays and summaries relative to his or her investment portfolio without requiring the client or customer to reorient between displays. What is also needed is such a method and system that provides an information continuum whereby the client can relatively easily navigate through the data and the data displays such that the information presented becomes easier to assimilate and understand, thereby becoming more meaningful to the client. One advantage of such a method and system is that the client or customer is able to assimilate the information in a shorter period of time. Another advantage is that the investment professional can spend less time explaining the raw data and the data displays, thereby leaving more time for discussions with the client as to future strategies and investment decisions. The method and system of the present invention has obtained these objects.

### SUMMARY OF THE INVENTION

The method and system of the present invention is a unique data display tool for use in the investment area that utilizes color coded entries in various data displays to aid in the client's assimilation of information. More specifically, the method and system uses a plurality of colors that are superimposed over data contained in various data displays. Any one data display may contain a number of different such color overlays. However, as between different data displays, the same colors would be used for the same data presented in each. It should also be mentioned that this inventor has coined the name MARSHALL'S SPECTRUM INVESTING CONCEPT^{SM} as a tradename for the method and system disclosed herein.

The foregoing and other features of the method and system of the present invention will become apparent from the detailed description that follows.

### BRIEF DESCRIPTION OF THE DRAWINGS

FIG. 1 is a first exemplary data display of the type that may utilize the method and system of the present invention.

FIG. 2 is a second exemplary data display of the type that may also utilize the method and system of the present invention.

### DETAILED DESCRIPTION

As previously mentioned, the method and system of the present invention is a unique data display tool for use in the investment area. The method and system utilizes color coded entries in various data displays to aid in the client's assimilation of information. The method and system generally uses a plurality of colors that are superimposed over data contained in different data displays. Any one data display may contain a number of different such color overlays. As between different data displays, however, the same colors would be used for the same data presented in each.

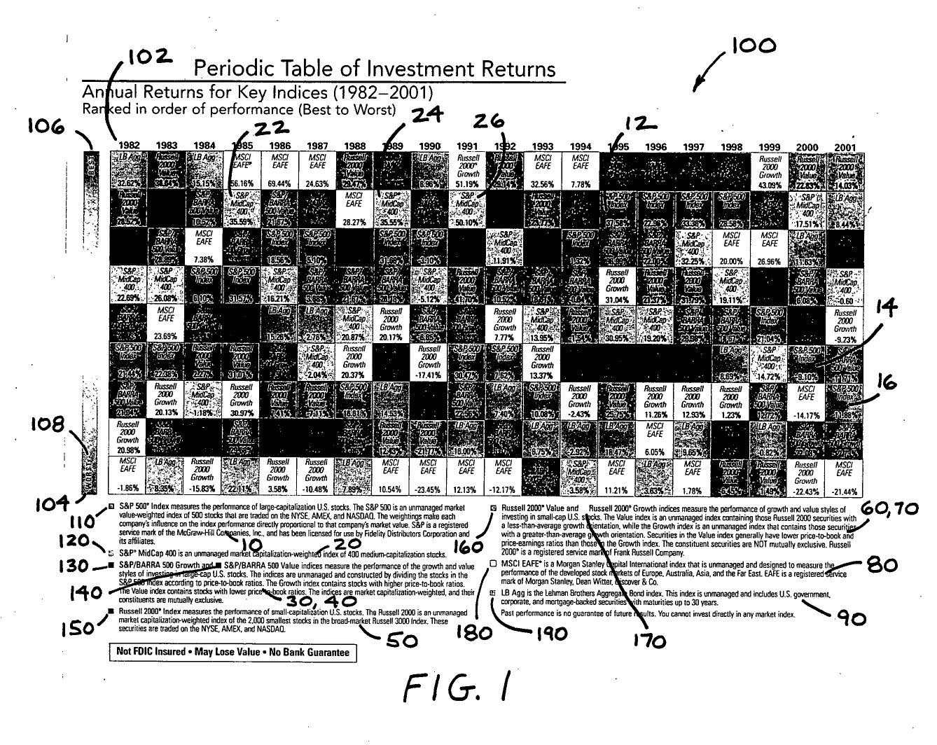

Referring now to the drawings in detail wherein like numbers represent like elements throughout, FIG. 1 illustrates a sample of a two-dimensional fictitious data display, generally identified 100, showing historical investment portfolio data. More specifically, the historical investment data display 100 includes a tabular display of data by years 102 and performance ranking 104. The years 102 displayed range from 1982 to 2001, inclusive, along the horizontal. The performance ranking 104 ranges from best performers 106 at the top of the display 100 to worst performers 108 at the bottom. Various investment indices are identified in a color legend 101 located at the bottommost portion of the display 100. Each investment index is assigned a color that is used uniformly throughout this first data display 100. It should be understood, however, that the types of indices identified in this preferred embodiment are for illustration purposes only. The number and types of indices could be varied without deviating from the scope of the present invention. For example, real estate indices could be included without deviating from the scope of the present invention. Additionally, some of the indices could be deleted and other indices could be included without departing from the scope of the present invention.

For example, the S&P 500® Index notation 10 is included in the legend 101 and is identified as a green color 110 within the legend 101 as well as at various points within the display 100 (“S&P 500” is a registered service mark of McGraw-Hill Companies, Inc.). In this particular display 100, the S&P 500® Index notation 10 identifies the performance of large capitalization United States stocks. As stated in the legend 101, the S&P 500® Index 10 is an unmanaged market value-weighted index of five hundred stocks that are publicly traded. The weightings make each company's influence on the index performance directly proportional to that company's market value.

Similar notations are included within the legend 101 for the S&P MidCap 400 index 20, the S&P/BARRA 500 Growth index 30, the S&P/BARRA 500 Value index 40, the Russell 2000® Index 50, the Russell 2000® Value index 60, the Russell 2000® Growth index 70, the MSCI EAFE® index 80, and the LB Agg index 90 (“Russell 2000” is a registered service mark of Frank Russell Company and “EAFE” is a registered service mark of Morgan Stanley, Dean Witter, Discover & Co.) Each such index 10, 20, 30, 40, 50, 60, 70, 80, 90 is included in each year 102 of the display for purposes of illustrating how that particular index performed in any given year. The ranking 104, 106 is an indicator of overall performance for that year. For example, in the years 1995 through 1998, the S&P 500® Index 10 is shown 12 to be one of the top investment performers. In the years 2000 and 2001, it is shown 14, 16 to be one of the worst. The trends in this performance are readily identifiable with the green color 110 associated with that corresponding index 10. It is also to be understood that other colors could be assigned to each such index without deviating from the scope of the present invention. The particular colors identified in this specification are, however, believed by this inventor to further maximize the quick assimilation and understanding of presented investment data.

Referring again to the legend 101 in FIG. 1, the S&P MidCap 400 index 20 is an unmanaged market capitalization-weighted index of four hundred medium-capitalization stocks. In the legend 101, this index 20 is illustrated as having a pale blue color 120 associated with it. The S&P MidCap 400 index 20 is shown as being a fairly consistent and good investment as shown by its performance ranking 22, 24, 26, in the years 1985, 1989 and 1991, respectively.

Similarly, notations for the S&P/BARRA 500 Growth index 30 and the S&P/BARRA 500 Value index 40 are also given in the legend 101 of the historical display 100. These indices 30, 40 measure the performance of the growth and values styles of investing in large-capitalization United States stocks, respectively. These indices 30, 40 are unmanaged and constructed by dividing the stocks in the S&P 500® Index 10 according to price-to-book ratios. The Growth index 30 contains stocks with higher price-to-book ratios. The Value index 40 contains stocks with lower price-to-book ratios. The indices 30, 40 are market capitalization-weighted and their constituents are mutually exclusive. The Growth index 30 is readily identified by a red color 130. The Value index 40 is identified by a violet purple color 140.

The legend 101 also includes a brown color 150 for denoting the Russell 2000® Index 50. This Index 50 measures the performance of small-capitalization United States stocks. The legend 101 includes a light orange color 160 for denoting the Russell 2000® Value index 60 and a yellow color 170 for the Russell 2000® Growth index 70. These indices 50, 60 measure the performance of growth and value styles of investing in small-capitalization United States stocks.

Finally, the legend 101 includes white 180 which identifies the MSCI EAFE® index 80, an unmanaged international index that is designed to measure the performance of the developed stock markets of Europe, Australia, Asia and the Far East. The LB Agg index 90 is a Lehman Brothers Aggregate Bond index that is also unmanaged and includes United States government, corporate, and mortgage-backed securities with maturities up to thirty years. This index 90 is identified by an aqua blue color 190.

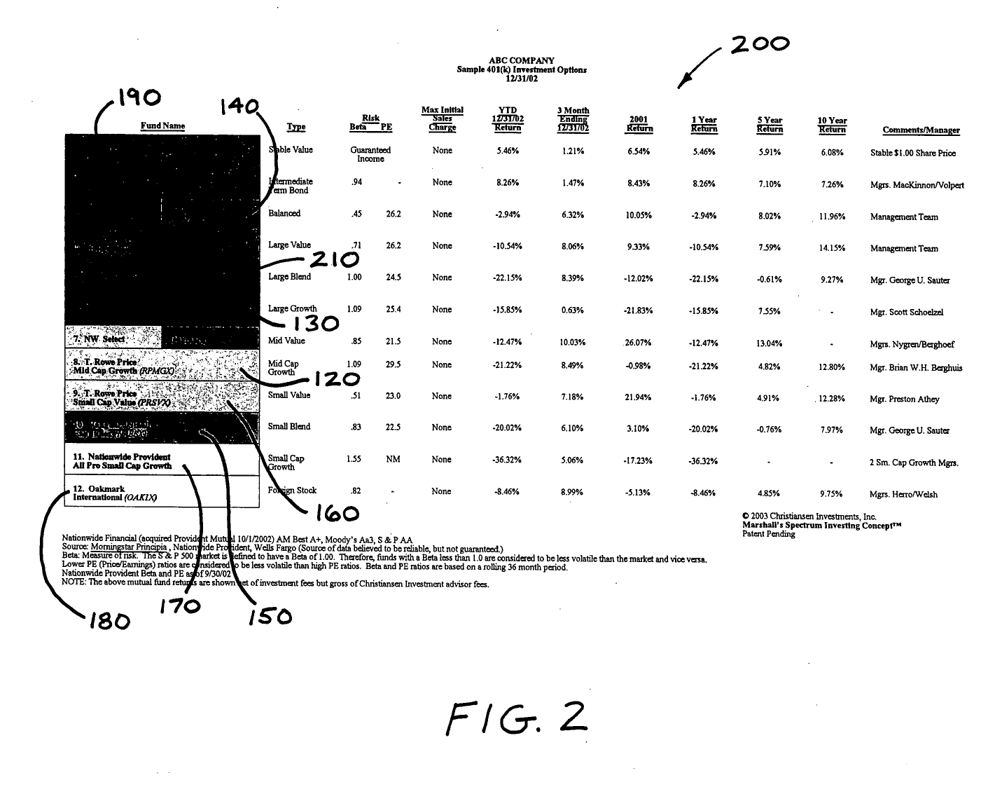

Referring now to FIG. 2, the preferred embodiment of an investment result summary, generally identified 200, for a particular, though fictitious, client is illustrated. In it, certain funds, including particular funds that would be included in the indices referred to above, are included. More importantly, those particular funds are color coded in accordance with the color scheme previously described as being used with the historical data display 100. For example, the Vanguard 500 Index Fund 210, shown in FIG. 2, is listed in the investment result display 200 with a green color 110 background. This background corresponds to the same green color 110 that is used in the historical display 100 that is illustrated in FIG. 1. In this fashion, the client, or any other viewer of this investment information for that matter, can quickly associate that fund 210 as being of the type that would be included in the S&P 500® Index 10 that is illustrated in the historical display 100, and vice versa. For the same reason, and to the same end, other entries in the investments results display 200 are similarly color coded such that the pale color 120, the red color 130, the violet purple color 140, the brown color 150, the light orange color 160, the yellow color 170, the white 180, and the aqua blue color 190 are each associated with the corresponding indices 20, 30, 40, 50, 60, 70, 80, 90, respectively, as illustrated in the historical display 100 as shown in FIG. 1.

It is also to be understood that the method and system of the present invention is not limited to providing only the preferred historical display 100 and the specific investment results display 200 as disclosed herein. The present method and system could also include any number of like displays including multimedia displays such as slide presentations, video displays, or other like technologies containing like investment information. The method and system of the present invention could be utilized to provide the same color coding to investment brochures and promotional literature of the company or entity that provides such investment data to its clients and customers.

Based on the foregoing, it will be apparent that there has been provided a new, useful and nonobvious data display method and system for use in the investment area that utilizes color coded entries in various data displays to aid in the client's assimilation of information. The method and system of the present invention uses a plurality of colors that are superimposed over data contained in various data displays. Any one data display may contain a number of different such color overlays. However, as between different data displays, the same colors would be used for the same data presented in each.

The principles of this invention having been fully explained in connection with the foregoing, I hereby claim as my invention:

1. A method for visually displaying investment data which comprises the steps of
providing a first display of investment data,
assigning a color to one category of data contained within said first investment data display,
assigning at least one other color to at least one other category of data contained within said first investment data display,
providing at least one additional investment data display, and
assigning the same colors to like categories of data contained within said at least one additional data display,
wherein a viewer of such data displays can readily associate like data between said data displays and can also quickly assimilate information contained within said data displays.

2. The visual display method of claim 1 wherein said first display providing step includes providing an historical investment data display and said additional display providing step includes providing an investments results summary.

3. The visual display method of claim 2 wherein said historical investment data display step includes providing investment data and arranging said investment data in a year-by-year display combined with a best-to-worst display.

4. The visual display method of claim 3 wherein said investment data includes one or more investment indices.

5. The visual display method of claim 4 wherein each investment index is assigned a specific color, which color is unique to that index and is consistently used with each data display.

6. The visual display method of claim 5 wherein one or more of the colors of green, pale blue, red, violet purple, brown, light orange, yellow, white and aqua blue is assigned to one or more of the investment indices used with the displays.

7. A method for visually displaying investment data which comprises the steps of
providing one set of investment data,
providing a first display of said investment data set,
assigning a color to each set of investment data contained within said first investment data display,
providing at least one other set of investment data,
assigning at least one other color to said at least one other set of investment data contained within said first investment data display,
providing at least one additional investment data display, and
assigning the same colors to like sets of data contained within said at least one additional data display,
wherein a viewer of such data displays can readily associate like data between said data displays and can also quickly assimilate information contained within said data displays.

8. The visual display method of claim 7 wherein said first display providing step includes providing an historical investment data display.

9. The visual display method of claim 8 wherein said additional display providing step includes providing an investments results summary.

10. The visual display method of claim 9 wherein said investment data includes one or more investment indices.

11. The visual display method of claim 10 wherein each investment index is assigned a specific color, which color is unique to that index and is consistently used with each data display.

12. The visual display method of claim 11 wherein one or more of the colors of green, pale blue, red, violet purple, brown, light orange, yellow, white and aqua blue is assigned to one or more of the investment indices used with the displays.

13. A visual display system for displaying investment data in one or more display means comprising
a first display of investment data,
a first color assigned to one category of data contained within said first investment data display,
at least one other color assigned to at least one other category of data contained within said first investment data display,
at least one additional investment data display, and
means for assigning the same colors to like categories of data contained within said at least one additional data display,
wherein a viewer of such data displays can readily associate like data between said data displays and can also quickly assimilate information contained within said data displays.

14. The visual display system of claim 13 wherein said first display includes an historical investment data display and said additional display includes an investments results summary.

15. The visual display system of claim 14 wherein said historical investment data display includes investment data and means for arranging said investment data in a year-by-year display combined with a best-to-worst display.

16. The visual display system of claim 15 wherein said investment data includes one or more investment indices.

17. The visual display system of claim 16 wherein each investment index is assigned a specific color, which color is unique to that index and is consistently used with each data display.

18. The visual display system of claim 17 wherein one or more of the colors of green, pale blue, red, violet purple, brown, light orange, yellow, white and aqua blue is assigned to one or more of the investment indices used with the displays.
